(19) United States
(12) Patent Application Publication
(10) Pub. No.: US 2014/0350213 A1
(43) Pub. Date: Nov. 27, 2014

(54) Purification of polyamide particles

(71) Applicant: BASF SE, Ludwigshafen (DE)

(72) Inventors: Faissal-Ali El-Toufaili, Ludwigshafen (DE); Achim Stammer, Freinsheim (DE); Jens Becker, Eisenberg (DE); Karsten Daunke, Ludwigshafen (DE); Thomas Sauer, Dirmstein (DE)

(73) Assignee: BASF SE, Ludwigshafen (DE)

(21) Appl. No.: 13/934,849

(22) Filed: Jul. 3, 2013

Related U.S. Application Data
(60) Provisional application No. 61/668,488, filed on Jul. 6, 2012.

(51) Int. Cl. C08G 69/16

(52) U.S. Cl. CPC C08G 69/16
USPC 528/323

(57) ABSTRACT

The present invention relates to a process for purifying polyamide particles wherein these are contacted with a lactam-containing treatment medium with or without a gaseous treatment medium.

### BACKGROUND OF THE INVENTION

The present invention relates to a process for purifying polyamide particles wherein these are contacted with a lactam-containing treatment medium with or without a gaseous treatment medium.

### RELATED ART

Polyamides are among the polymers with large production volumes worldwide and are mainly used in fibers, engineering materials and film/sheet but also for a multiplicity of other purposes. Nylon-6 is the most widely produced polyamide, its share being about 57%. Hydrolytic polymerization of ε-caprolactam is the classic way to produce nylon-6 (polycaprolactam) and is industrially still very significant. It is described for example in Kunststoff Handbuch, ¾ Engineering Thermoplastics: Polyamides, Carl Hanser Publishers, 1998, Munich, pages 42-47 and 65-70. Hydrolytic polymerization leads to an equilibrium becoming established between nylon-6, oligomeric components, monomers and water. The level of oligomers and monomers can be 8 to 15 wt % for example, so at least partial removal is required before further processing. This is typically accomplished by extraction with water at elevated temperature. But this generates dilute aqueous solutions of caprolactam, which are inconvenient to work up. This also holds for polyamides which in lieu of or in addition to caprolactam are constructed from polyamide-forming diamines and dicarboxylic acids. In general, monomers and oligomers have to be removed from such polyamides to an extent where the properties required for further processing are ensured.

DD-A-206 999 discloses a process for purifying polyamide particles wherein these are extracted with water in countercurrent. One disadvantage with this process is the high energy required to evaporate the water to separate it from the extracted components. Another disadvantage is that polyamides tend to imbibe water (swell) on prolonged contact with water at elevated temperature in particular, which may lead to undesired changes in the properties of the material. The water thus imbibed by the polyamide particles has to be got rid of again by drying, and that is likewise associated with high energy requirements.

EP-A-284 968 discloses a process for removing caprolactam monomer and oligomer from polyamide particles by treatment with inert gases at elevated temperature. The disadvantage with the specifically taught treatment with superheated steam is the high level of energy needed to generate the large quantities of steam needed.

It is known that caprolactam monomer acts as a solubilizer for caprolactam oligomer in the extraction of nylon-6. Aqueous solutions of caprolactam are accordingly often used for extracting nylon-6.

WO 99/26996 and WO 99/26998 describe a process for continuous extraction of polyamides wherein polyamide particles are treated with recirculated aqueous caprolactam solution in a vertical extraction column.

JP-A-45 025 519 discloses a multi-stage extraction process wherein the polyamide chip material is extracted with a 5 to 50% aqueous caprolactam solution in the first stage and with a 0.1 to 5% aqueous caprolactam solution in the second stage, both at 70 to 120° C.

JP-A-51 149 397 describes the extraction with an aqueous 60 wt % caprolactam solution at 80 to 120° C. for 3 to 8 hours in the first stage and the extraction with caprolactam-free water, which preferably is O₂-free or comprises small amounts of a reducing agent, in the last stage.

In JP-A-53 071 196, polyamide is initially extracted with a hot aqueous medium and then treated in an inert gas stream at temperatures of 10 to 50° C. below the melting point of polyamide, wherein the hot aqueous medium comprises for example water at 80 to 130° C. with less than 50 wt % of 8-caprolactam.

In DE-A-195 05 150, caprolactam oligomers are removed from a polyamide chip material by treatment at 60 to 150° C. with purely caprolactam monomer as extractant. But this process has the disadvantage that adherent caprolactam may cause the chip material to stick together in subsequent process steps.

The extraction of polyamide particles with water, steam and/or lactam-containing extractants is still in need of improvement. Either the residual extractables content of the chip material is too high, or the aqueous extract has to be concentrated to a substantial degree, which has appreciable energy requirements, before the lactam monomer and oligomer can be recycled into the polymerization. What is still needed in particular is an integrated system for hydrolytic polymerization and purification of polyamide particles thus obtained whereby the fractions generated in the purification, which comprise lactam, polyamide oligomers and water, can ideally be recycled back into the polymerization without further workup. More particularly, removal of water shall very largely become unnecessary.

The present invention has for its object to provide a simple and efficient process for purifying polyamide particles. This process shall preferably enable the removal of monomers and oligomers to obtain polyamide particles having a very low residual extractables content. Specifically, the process shall have low energy requirements. It shall further enable integration for hydrolytic polymerization and purification of the resulting crude particles of polymer. Ideally, the water quantity generated in purification shall not exceed the water quantity required to kick off the hydrolytic polymerization. Again, ideally, the amount of monomers and oligomers which is generated in purification shall not exceed the amount of monomers and oligomers which is used for hydrolytic polymerization.

We have found that this object is achieved by a novel and improved process for purifying polyamide particles wherein these are subjected to a treatment with at least one lactam and additionally with at least one gaseous treatment medium.

### SUMMARY OF THE INVENTION

The invention provides a process for producing polyamide particles, which comprises
a) providing crude particles of polyamide,
b) contacting the crude particles of polyamide provided in step a) in a treatment zone with a first liquid treatment medium (B1) comprising at least one lactam and removing the laden treatment medium (B1),
c) optionally contacting the crude particles of polyamide additionally with a second gaseous treatment medium (B2).

In a preferred embodiment of the process according to the present invention, the crude particles of polyamide are provided in step a) by
a1) providing a monomer mixture comprising at least one lactam monomer and/or oligomer,
a2) reacting the monomer mixture provided in step a1) in a hydrolytic polymerization in the presence of water to obtain a reaction mixture comprising polyamide, water, unconverted monomers and oligomers, and
a3) forming the reaction mixture obtained in step a2) into crude particles of polyamide.

The present invention further provides for the use of purified particles of polyamide obtainable by a process as defined hereinabove and hereinbelow for producing chips, film/sheet, fibers or shaped articles.

### DESCRIPTION OF THE INVENTION

The process of the present invention has the following advantages:
The purification process of the present invention is simple and efficient.
The process provides a distinct reduction in the level of monomeric and oligomeric components in the polyamide particles.
The process of the present invention particularly provides a distinct reduction in the level of cyclic dimer in the polyamide particles.
The polyamide particles obtained generally have a distinctly increased viscosity number in relation to the crude particles of polyamide.
The process of the present invention provides a distinct saving in energy compared with conventional processes of purification. The amount of water required is distinctly reduced compared with conventional extraction using water in the liquid phase. This also reduces the energy required to concentrate the extracted lactam and to dry the purified polyamide. Even compared with conventional extraction using water in the gas phase, a distinct reduction is achieved in the amount of water required and thus in the energy required for steam production.
The polyamide particles obtained are so pure that use to produce various products is possible without disruptive effects.
An integrated concept of a process for producing and purifying polyamide particles can be actualized.

For the purposes of the present invention, a monomeric component is a low molecular weight compound as used in the production of crude particles of polyamide to introduce a single repeat unit. This includes the compounds used to produce the crude particles of polyamide, such as lactams, dicarboxylic acids and derivatives thereof, diamines, amino acids and derivatives thereof, such as amino carbonitriles, amino carboxamides, amino carboxylate esters, amino carboxylate salts, etc.

For the purposes of the present invention, an oligomeric component is a compound as are formed in the production of crude particles of polyamide by reaction of at least two compounds forming the individual repeat units. The oligomeric components in question have a lower molecular weight than the polyamides in the polyamide particles. The oligomeric components include cyclic and linear oligomers, specifically cyclic dimer, linear dimer, trimer, tetramer, pentamer, hexamer and heptamer. Commonly used methods to determine the oligomeric components of polyamide particles generally capture the components up to the heptamer. The process of the present invention more particularly provides a distinct reduction in the level of cyclic dimer in the polyamide particles.

The viscosity number (Staudinger function, referred to as VZ, VN or J) is defined as VZ=1/c×−(η−ηₛ)ηₛ. The viscosity number is in direct correlation with the average molar mass of the polyamide, and provides information about the processability of a plastic. The viscosity number can be determined in accordance with DIN 51562 Part 1 using an Ubbelohde viscometer.

### Step a) Providing Crude Particles of Polyamide

The level of oligomeric components in the crude particles of polyamide is generally in the range from 0.3 to 20 wt %, preferably 0.35 to 15 wt % and more preferably 0.4 to 5 wt %, based on the total weight of polyamide particles.

The level of monomeric components in the crude particles of polyamide is generally not more than 15 wt %. The level of monomeric components is preferably in a range of 0.001 to 15 wt %, more preferably of 0.1 to 12 wt % and especially of 0.8 to 10 wt %, based on the total weight of polyamide particles.

The crude particles of polyamide in the process of the present invention are suitably particles in any form, for example in the form of chips, pellets, granules, beads, platelets.

The size of the crude particles of polyamide can be varied within wide limits. The average diameter of the crude particles of polyamide is preferably in the range from 0.1 to 10 mm, more preferably in the range from 0.2 to 5 mm and especially in the range from 1 to 4 mm.

The crude particles of polyamide used in the process of the present invention may generally comprise any desired polyamides. The crude particles of polyamide used in the process of the present invention are obtainable by methods known per se. These are described for example in EP-B-1 235 671, EP-B-732 351, EP-A-348 821, EP-A-702 047 and EP-A-284 968.

For the purposes of the present invention, the term polyamides comprises homopolymers, copolymers, polymer blends and graft copolymers where the main chain or a side chain of the polymer includes repeat units as an essential component which are derived from at least one lactam.

Examples of polyamide homopolymers are nylon-6 (PA 6, polycaprolactam), nylon-7 (PA 7, polyenantholactam or polyheptanamide), nylon-10 (PA 10, polydecanamide), nylon-11 (PA 11, polyundecanelactam) and nylon-12 (PA 12, polydodecanelactam).

Polyamide copolymers may comprise the polyamide-forming units in various ratios. Examples of polyamide copolymers are nylon 6/66 and nylon 66/6 (PA 6/66, PA 66/6, i.e., copolyamides of PA 6- and PA 66-building blocks, prepared from caprolactam, polyhexamethylenediamine and adipic acid).

The term polyamides also comprises partly aromatic polyamides. Partly aromatic polyamides derive generally from aromatic dicarboxylic acids, such as terephthalic acid or isophthalic acid, and a linear or branched aliphatic amine. PA 6T/6 is preferred.

The crude particles of polyamide used in the process of the present invention preferably comprise polyamides selected from nylon-6, nylon-11, nylon-12, nylon-7, nylon-8, nylon-9, nylon-10 and their copolyamides and copolymers thereof. Particular preference is given to nylon-6 and nylon-12, nylon-6 is especially preferred.

The process of the present invention preferably utilizes polymer particles from a hydrolytic polymerization of at least one lactam. Specifically, the process of the present invention provides nylon-6 polymer particles from a hydrolytic polymerization of ε-caprolactam and/or an oligomer thereof.

A specific embodiment is a process wherein the crude particles of polyamide are provided in step a) by
a1) providing a monomer mixture comprising at least one lactam monomer and/or oligomer,
a2) reacting the monomer mixture provided in step a1) in a hydrolytic polymerization in the presence of water to obtain a reaction mixture comprising polyamide, water, unconverted monomers and oligomers, and
a3) forming the reaction mixture obtained in step a2) into crude particles of polyamide.

A suitable process for producing polyamides and specifically nylon-6 by hydrolytic polymerization is described for example in Kunststoff Handbuch, ¾Engineering Thermoplastics: Polyamides, Carl Hanser Publishers, 1998, Munich, pages 42-47 and 65-70. This disclosure is fully incorporated herein by reference.

The monomer mixture provided in step a1) preferably comprises at least one C₅ to C₁₂ lactam and/or an oligomer thereof. The lactams are more particularly selected from ε-caprolactam, 2-piperidone (δ-valerolactam), 2-pyrrolidone (γ-butyrolactam), capryllactam, enantholactam, lauryllactam, laurolactam, their mixtures and oligomers thereof. Particular preference is given to providing a monomer mixture in step a1) which comprises ε-caprolactam and/or an oligomer thereof.

In a specific embodiment, the process of the present invention utilizes polymer particles from the hydrolytic polymerization of ε-caprolactam.

The monomer mixture provided in step a1) may be reacted in a hydrolytic polymerization in step a2) according to customary methods known to a person skilled in the art. Such methods are described for example in Kunststoff Handbuch, ¾ Engineering Thermoplastics: Polyamides, Carl Hanser Publishers, 1998, Munich, pages 42-47 and 65-70. This disclosure is fully incorporated herein by reference.

Preferably, in step a2), to effect hydrolytic polymerization, a lactam is subjected to a ring opening by agency of water. In the process, for example, the lactam is at least partially split into the corresponding amino carboxylic acid which in a subsequent step is then further polymerized by polyaddition and polycondensation. When, in a preferred embodiment, a monomer mixture is provided in step a1) which comprises caprolactam, this caprolactam is opened at least partially to the corresponding aminocaproic acid by the agency of water and then reacts by condensation and polyaddition to form the nylon-6.

The reaction in step a2) is preferably carried out in a continuous manner.

The hydrolytic polymerization in step a2) is preferably carried out in the presence of 0.1 to 4 wt % of water and more preferably 0.2 to 3.5 wt % of water, based on lactam. The lactam concerned is specifically caprolactam.

The hydrolytic polymerization in step a2) can take place in the presence of at least one chain transfer agent, such as acetic acid.

The reaction in step a2) can be carried out in one or more stages. In a first embodiment, the reaction in step a2) is carried out in one stage. In this case it is preferable for the lactam to be reacted with water and any additives in one reactor.

The customary reactors for producing polyamides and known to a person skilled in the art are suitable. Preferably, the hydrolytic polymerization in step a2) takes place in one polymerization tube or in a bundle of polymerization tubes. The hydrolytic polymerization in step a2) is specifically carried out using at least one so-called VK tube. The abbreviation “VK” comes from the German, where it is used for a simplified continuous process. When the reaction in step a2) is carried out in a multi-stage form, it is preferable for at least one of the stages to take place in a VK tube. In a two-stage form for the reaction in stage a2) it is preferably the second stage which takes place in a VK tube.

Specifically nylon-6 is generally produced in a multi-stage process, specifically a two-stage process. Caprolactam, water and optionally at least one additive, for example a chain transfer agent, are fed into the first stage and converted into a prepolymer. This prepolymer can be transferred into the second stage under pressure or by a melt discharge pump directly or via a melt dryer.

Volatile components, for example excess water, can be removed from the reaction in a conventional manner, for example via a dephlegmator.

The hydrolytic polymerization in step a2) is preferably carried out at a temperature in the range from 240 to 280° C. When the hydrolytic polymerization in step a2) is carried out in multi-stage form, the individual stages can take place at the same temperature or at different temperatures. When a polymerization stage is carried out in a tubular reactor, specifically a VK tube, the reactor can have substantially the same temperature along its entire length. Another possibility is a temperature gradient in one part of the tubular reactor at least. Another possibility is to conduct the hydrolytic polymerization in a tubular reactor having two or more than two reaction zones, which are operated at differing temperature and/or differing pressure.

When the hydrolytic polymerization in step a2) is carried out in one stage, the pressure in the polymerization reactor is preferably in a range of about 0.5 bar up to 5 bar. A one-stage polymerization is more preferably carried out at ambient pressure.

In a preferred embodiment, the hydrolytic polymerization in step a2) is carried out in two stages. The pressure in the first stage is preferably in a range of about 1 bar up to 20 bar and more preferably in a range of 2 bar to 10 bar. The pressure in the second stage is preferably in a range of about 0.5 bar up to 5 bar, especially at ambient pressure. Topping with a first polymerizing stage in the form of a pressure stage will generally speed up the process since the rate-determining step of cleaving the lactam, specifically the caprolactam, takes place under elevated pressure. Otherwise, the polymerization in the first stage is generally carried out under similar conditions to the second reaction stage. The second stage then preferably takes place in a VK tube as described above.

The effluent from the hydrolytic polymerization in step a2) is subsequently used in step a3) to form the crude particles of polyamide. Conventional pelletization is a preferred way to do this. For example, the melt from the VK tube can be fed to a pelletizer using a suitable conveying device. Heatable pumps are examples of suitable conveying devices. In general, the polymer melt is initially extruded and the extrudates are subsequently pelletized. Underwater pelletizers are an example of suitable pelletizers.

The polyamide particles used in the process of the present invention may additionally comprise customary additives such as delustering agents, e.g., titanium dioxide, nucleators, e.g., magnesium silicate, stabilizers, e.g., copper(I) halides and alkali metal halides, antioxidants, reinforcing agents, etc, in customary amounts. Additives are generally added before, during or after polymerization and before pelletization. In the above-described specific embodiment of step a) in the form of steps a1) to a3), the additives are generally added before, during or after the polymerization (step a2)) and before the forming (step a3)), for example by pelletization.

### Step b)

The first treatment medium (B1) is in liquid form when being brought into contact with the crude particles of polyamide.

The melting point of the first treatment medium (B1) is preferably at not more than 150° C. and more preferably at not more than 100° C. ε-Caprolactam has a melting point of 69.2° C., for instance.

The lactam used is preferably a lactam as also present in polymerized form in the crude particles of polyamide.

C₅ to C₁₂ lactams are preferred. Said lactams are particularly selected from 8-caprolactam, 2-piperidone (δ-valerolactam), 2-pyrrolidone (γ-butyrolactam), capryllactam, enantholactam, lauryllactam, laurolactam or mixtures thereof. Preference is given to caprolactam, lauryllactam or mixtures thereof. It is particularly preferable for the first treatment medium (B1) to contain or consist of caprolactam.

In a first variant, the first treatment medium (B1) consists exclusively of at least one lactam. Specifically, the first treatment medium (B1) consists exclusively of caprolactam.

In a second variant, the first treatment medium (B1) comprises at least one lactam and at least one treatment medium other than said at least one lactam. Water is preferred for use as treatment medium other than lactams. In this version a lactam/water mixture is used as first treatment medium (B1).

When the first treatment medium (B1) comprises water, the water fraction is preferably 0.5 to 50 wt %, more preferably 1 to 25 wt % an especially 2 to 20 wt %, based on the total weight of the first treatment medium (B1). More preferably a lactam/water mixture with a lactam content of 50 to 90 wt % is used, based on the total weight of treatment medium (B1). Used especially is a caprolactam/water mixture with a caprolactam content of 50 to 90 wt %, based on the total weight of the first treatment medium (B1).

The second treatment medium (B2) is preferably selected from gases that are inert under the treatment conditions.

It is particularly preferable for the second treatment medium (B2) to be selected from steam, nitrogen, helium, neon, argon, CO₂ and mixtures thereof. More particularly, the second treatment medium (B2) is selected from steam, nitrogen and mixtures thereof. In one specific embodiment, nitrogen is used as second treatment medium.

Contacting the crude particles of polyamide with the first liquid treatment medium (B1) is effected in an apparatus which is customary therefor, preferably an extraction apparatus. Such extraction apparatuses for polyamide extraction with a liquid treatment medium are in principle known to a person skilled in the art.

Contacting the crude particles of polyamide with the first liquid treatment medium (B1) can be effected batchwise or continuously. Contacting the first liquid treatment medium (B1) is preferably effected continuously.

Contacting the crude particles of polyamide with the first liquid treatment medium (B1) can be effected cocurrently or countercurrently. Contacting with the first liquid treatment medium (B1) is preferably effected countercurrently.

In one specific embodiment, the crude particles of polyamide are contacted with the first liquid treatment medium (B1) in step b) in a treatment zone in which the polyamide particles move downwardly in accordance with the force of gravity and the liquid treatment medium (B1) is made to travel upwardly in countercurrent thereto contrary to the force of gravity.

The treatment zone in step b) of the process according to the present invention is preferably substantially vertical. The term “substantially vertical” is to be understood as meaning that the treatment zone does not need to be exactly perpendicular to the Earth's surface, but can deviate therefrom by up to 30° and preferably by up to 20°.

The crude particles of polyamide can be fed to the treatment zone using a customary transporting device, for example a belt conveyor, a screw conveyor or via a transport water circuit. When a transport water circuit is used, the crude particles of polyamide can be separated from the transport water before entry into the treatment zone via a separating device.

The crude particles of polyamide are preferably introduced at the top of the treatment zone. They then flow downwardly through the treatment zone under gravity and are discharged from the treatment zone in the bottom region thereof.

The treatment medium (B1) can be fed to the treatment zone via one feedpoint or via two or more different feedpoints.

In a first variant, the treatment medium (B1) is exclusively introduced into the treatment zone in the region of the end where the polyamide particles are discharged. When a substantially vertical treatment zone is used in this variant, the treatment medium (B1) is exclusively introduced in the bottom region of the treatment zone.

In a second variant, a sub-stream of treatment medium (B1) is introduced into the treatment zone in the region of the end where the polyamide particles are discharged. When a substantially vertical treatment zone is used in this variant, a sub-stream of treatment medium (B1) is introduced into the treatment zone in the bottom region thereof. A further sub-stream of treatment medium (B1) is introduced into the treatment zone via one or more feedpoints upstream of the feedpoint for the first sub-stream.

When the treatment medium (B1) is fed to the treatment zone via two or more different feedpoints, the sub-streams fed can each have the same or different compositions.

Preferably, the lactam content of the sub-stream of treatment medium (B1) introduced into the treatment zone in the region of the end where the polyamide particles are discharged is higher than the lactam content of the sub-stream of treatment medium (B1) which is fed to the treatment zone via one or more feedpoints located upstream of the feedpoint of the first sub-stream.

In a particularly preferred embodiment of the process according to the present invention, exclusively at least one lactam, preferably exclusively ε-caprolactam, is fed as treatment medium (B1) into the treatment zone in the region of the end where the polyamide particles are discharged.

In a further particularly preferred embodiment of the process according to the present invention, a water-lactam mixture or pure water is fed as treatment medium (B1) into the treatment zone via one or more feedpoints located upstream of the feedpoint for the first sub-stream.

The weight ratio of treatment medium (B1) to polyamide particles is preferably in a range of 0.01:1 to 1000:1, preferably 0.05:1 to 100:1, more preferably 0.1:1 to 20:1 and especially 0.4:1 to 1:1.

The process of the present invention enables specifically an ideally complete integration of hydrolytic polymerization and purification of polyamide particles thus obtained. Ideally, the water quantity generated in the purification should not exceed the water quantity required to kick off the hydrolytic polymerization. Again, ideally, the amount of monomers and oligomers which is generated in the purification should not exceed the amount of monomers and oligomers which is used for hydrolytic polymerization.

Preferably, the contacting of treatment medium (B1) with the crude particles of polyamide in step b) is effected continuously and the weight ratio of laden treatment medium (B1) removed per unit time to polyamide particles discharged from the treatment zone per unit time is preferably in a range of 0.01:1 to 1:1, more preferably 0.05:1 to 0.5:1 and especially 0.1:1 to 0.35:1. The weight of the laden treatment medium (B1) removed per unit time is based on treatment medium (B1) actually discharged (removed) from treatment step b) and not to recirculated treatment medium (B1).

The aforementioned low feed rates of treatment medium (B1) are obtainable for example through appropriate control of flow speeds for treatment medium (B1) and polyamide particles through the treatment zone. A high flow speed for the polyamide particles through the treatment zone coupled with a low flow speed for the treatment medium (B1) through the treatment zone leads to correspondingly low feed rates of treatment medium (B1).

The flow speed of polyamide particles through the treatment zone is preferably in a range of about 0.1 to 100 m/h, more preferably 1 to 50 m/h and especially 2 to 25 m/h.

The residence time ratio for polyamide particles/treatment agent is preferably in a range of 15 min to 60 h, more preferably 1 to 30 h and especially 3 to 15 h.

Additionally or alternatively to flow speeds being controlled, the aforementioned low feed rates are also obtainable by circulating the treatment medium (B1). In one specific embodiment of the process according to the present invention, the treatment medium (B1) or one or more than one sub-stream of treatment medium (B1) is recirculated. The treatment medium (B1) quantity circulated in the sub-stream is chosen so as to ensure an intensive mass transfer takes place at the phase boundary of polyamide particles. Some of the treatment medium (B1) is continuously removed from the circuit and replaced with fresh treatment medium (B1). In the case of two or more circuits, the laden treatment medium (B1) from a downstream circuit can be partly or wholly fed into an upstream circuit.

In one specific embodiment, the treatment medium (B1) is recirculated in at least one circuit, exclusively at least one lactam, preferably exclusively ε-caprolactam, is fed as treatment medium (B1) into the treatment zone in the region of the end where the polyamide particles are discharged, optionally a water-lactam mixture or pure water is additionally fed into the cycle stream, and laden treatment medium (B1) is removed from the treatment zone in the region of the end where the polyamide particles are introduced.

Contacting the crude particles of polyamide with the first liquid treatment medium (B1) is generally effected under conditions where the polyamide particles do not agglomerate, aggregate, coalesce, clump, become plastic, liquid or gaseous.

Contacting the crude particles of polyamide with the first liquid treatment medium (B1) in step b) is preferably effected at a temperature in the range from 50 to 180° C., preferably 70 to 170° C., and more preferably 80 to 150° C. In one specific embodiment, the crude particles of polyamide are contacted with the first liquid treatment medium (B1) in step b) at a temperature of not more than 150° C.

In one specific embodiment, the treatment zone in step b) has a higher temperature in the region where the crude particles of polyamide are introduced than in the region where the polyamide particles are discharged. It was found that the presence of such a temperature difference leads to polyamide particles being obtained which comprise particularly low levels of monomers and/or oligomers.

The temperature in the region where the crude particles of polyamide are introduced is preferably in a range of 125 to 170° C. and more preferably of 130 to 160° C. In one specific embodiment, the temperature in the region where the crude particles of polyamide are introduced is not more than 150° C.

The temperature in the region where the crude particles of polyamide are discharged is preferably in a range of 70 to 120° C. and more preferably of 75 to 110° C.

Preferably, the temperature difference between the region where the crude particles of polyamide are introduced and the region where the polyamide particles are discharged is not less than 5° C., more preferably not less than 10° C., especially not less than 20° C. and specifically not less than 40° C. The temperature difference between the region where the crude particles of polyamide are introduced and the region where the particles of polyamide are discharged is preferably not more than 80° C.

The temperature difference between the region where the crude particles of polyamide are introduced and the region where the particles of polyamide are discharged can be made continuous or staged.

Preferably, the crude particles of polyamide are contacted with the first liquid treatment medium (B1) at a pressure in the range from 0.01 to 10 bar, preferably 0.1 to 7 bar and more preferably 0.9 to 5 bar. Contacting is more particularly effected at standard pressure (atmospheric pressure).

The crude particles of polyamide can be contacted with the first liquid treatment medium (B1) under ambient atmosphere or inert gas atmosphere. Contacting is preferably effected under inert gas atmosphere. Preferred inert gases are selected from nitrogen, helium, neon, argon, CO₂ and mixtures thereof.

The treatment time with the first liquid treatment medium (B1) can be varied between wide limits and is generally in the range from 0.1 to 500 h, preferably in the range from 0.2 to 100 h and more preferably in the range from 0.5 to 50 h. In a continuous process, the overall residence time for polyamide particles in the treatment zone in step b) is preferably in a range of 3 to 50 h, more preferably 5 to 25 h.

In the continuous form of step b), the polyamide particles are discharged from the treatment zone via a screw, especially a deep-drawn single screw, for example. Screw speed is used to control the discharged amount of polyamide and thereby the polyamide level in the treatment zone. A screw ensures very uniform, abrasion-free discharge of the polyamide. Particle bridging is likewise avoided. Since this form of discharge can also be leakproof, the countercurrent concentration profile in the treatment zone is not disrupted. The addition of a small amount of water, which can be resupplied to the treatment zone through the screw, creates in the screw a liquid stream opposite to the exiting polyamide whereby back-mixing and wetting of the discharged ones with treatment agent (B1) is avoided.

In a batchwise embodiment for the process of the present invention, the laden treatment medium (B1) can be separated from the polyamide particles by filtration, centrifugation or a combination thereof. The laden treatment medium (B1) is preferably separated from the polyamide particles under conditions where the treatment medium (B1) is liquid. For this, the separation can take place at elevated temperature. Separation is specifically effected at elevated temperature when a highly lactam-containing mixture with water is used as treatment medium (B1) or when the treatment medium (B1) consists exclusively of at least one lactam, e.g., caprolactam. Specifically, the laden treatment medium (B1) is separated from the polyamide particles at a temperature in the range from 50 to 200° C., preferably 70 to 180° C. and more preferably 80 to 150° C. A heatable filtering device is preferably used for separation.

The laden treatment medium (B1) removed in step b) can in many cases be returned into a polymerization to provide the crude particles of polyamide in step a). In a preferred embodiment, the laden treatment medium (B1) removed in step b) is returned without further workup into a polymerization to provide the crude particles of polyamide in step a).

The process of the present invention thus provides specifically for an integration of hydrolytic polymerization and purification of the crude particles of polymer which are obtained therein.

In one specific embodiment of the process according to the present invention, crude particles of polyamide are provided in step a) from a hydrolytic polymerization of at least one lactam and the water quantity generated in step b) in the form of the laden treatment medium B1) does not exceed the water quantity required to kick off the hydrolytic polymerization in step a).

In one specific embodiment of the process according to the present invention, crude particles of polyamide are provided in step a) from a hydrolytic polymerization of at least one lactam and the amount of monomers and oligomers which is generated in step b) in the form of the laden treatment medium B1) does not exceed the amount of monomers and oligomers which is used in step a) for hydrolytic polymerization.

The removed laden treatment medium (B1) can be subjected to a workup, if desired. This is particularly the case when a lactam-water mixture is used as treatment medium (B1). In one specific embodiment, then, the laden treatment medium (B1) is subjected to a separation into a lactam-enriched fraction and a lactam-depleted fraction. For this, the laden treatment medium (B1) can be subjected to distillative separation for example. Useful separating devices include the customary distillation columns and evaporators, for example falling-film evaporators, forced circulation flash evaporators, short-path evaporators or thin-film evaporators. The lactam-enriched fraction is preferably returned into the polymerization. The lactam-depleted (and the correspondingly water-enriched) fraction can be reused to provide the liquid treatment medium (B1) or be removed from the process.

The fractions returned to the polymerization may have fresh lactam added to them, if desired. It is preferable to add from 0.01 to 50 wt % of fresh lactam, based on the total weight of the fraction returned into the polymerization.

The treatment with the second treatment medium (B2) can take place at the same time as the treatment with the first treatment medium (B1) or partly or wholly after the treatment with the first treatment medium (B1).

In one specific embodiment of the process according to the present invention, the treatment with the second treatment medium (B2) takes place at the same time as the treatment with the first treatment medium (B1). The treatment zone in step b) of the process according to the present invention is preferably substantially vertical in this embodiment also. Step b) of the process according to the present invention is preferably also carried out continuously in this embodiment. The crude particles of polyamide are preferably introduced into the treatment zone at the top in this embodiment also. The treatment medium (B2) can be fed to the treatment zone via one feedpoint or via two or more different feedpoints. In one specific embodiment, the treatment medium (B2) is exclusively introduced into the treatment zone in the region of the end where the polyamide particles are discharged. When a substantially vertical treatment zone is used in this variant, treatment medium (B2) is exclusively introduced in the bottom region of the treatment zone.

In a further specific embodiment of the process according to the present invention, the treatment with the second treatment medium (B2) takes place wholly after the treatment with the first treatment medium (B1).

It can be advantageous for the polyamide particles obtained on removing treatment medium (B1) to be subjected to a workup before being contacted with the second treatment medium (B2). Preferably, adherent lactam is removed from the polyamide particles obtained on removing the treatment medium (B1). Adherent lactam is preferably removed by centrifugation.

The crude particles of polyamide are contacted with the second gaseous treatment medium (B2) in an apparatus suitable for working with solid-gas mixtures. A person skilled in the art has in-principle knowledge of apparatuses of this type.

The treatment with the second treatment medium (B2) is preferably carried out using a substantially upright treatment apparatus. The treatment apparatus will generally have a length:diameter ratio of 5:1 to 30:1 and preferably of 7:1 to 15:1.

The polyamide particles are preferably introduced at the top of the treatment apparatus.

In one specific embodiment, preheated particles of polyamide are introduced into the treatment apparatus. The temperature of the particles of polyamide on entry into the treatment apparatus is preferably not less than 50° C. and more preferably not less than 70° C. To this end, the feed line for the polyamide particles can be heated, or a polyamide already preheated from pelletizing is used.

The polyamide particles are preferably treated with the second gaseous treatment medium (B2) in countercurrent or in crosscurrent, especially in countercurrent. The second gaseous treatment medium (B2) preferably passes upwardly through the treatment apparatus. Treatment medium (B2) can be introduced into the treatment apparatus in the region of the base thereof. Treatment medium (B2) is preferably introduced at two or more points in the flow direction of (B2) through the apparatus.

The temperature of contacting the crude particles of polyamide with the second gaseous treatment medium (B2) is preferably in a range of 70 to 250° C., more preferably 90 to 210° C. and especially 100 to 180° C. It is advantageous to maintain a temperature of about 10 to 60° C. below the melting point of the particular polyamide.

The pressure when the crude particles of polyamide are contacted with the second gaseous treatment medium (B2) is preferably in a range of 0.01 to 10 bar, more preferably 0.1 to 7 bar and even more preferably 0.9 to 5 bar.

When superheated steam is used as second gaseous treatment medium (B2), the treatment conditions are coordinated such that water is not present in the liquid phase. However, it is preferable not to use superheated steam as second gaseous treatment medium (B2). Nitrogen is preferably used as second gaseous treatment medium (B2).

The treatment time with the second gaseous treatment medium (B2) can be varied within wide limits and is generally in the range from 0.5 to 100 h, preferably in the range from 1 to 60 h and more preferably in the range from 2 to 40 h.

The feed rate of inert gas (B2) is preferably in the range from 1 to 10 standard m³ per kg of polyamide particles, preferably from 2 to 6 standard m³ per kg of polyamide particles.

The inert gas treatment heats up the polyparticles and provides an effective reduction in the level of any monomeric lactam still present, lactam oligomer and also generally in the water content.

The laden second gaseous treatment medium (B2) is preferably discharged from the treatment apparatus in the region of the upper end thereof.

The condensed components, in addition to lactam monomer, still comprise oligomers (if not removed with the first treatment medium) and generally water. The condensed components are preferably at least partly returned into a polymerization for producing polyamides.

Preferably, the second gaseous treatment medium (B2) is recirculated and reused for treating the particles of polyamide. To remove impurities from the system, a purge stream can be withdrawn from the cycle gas and replaced with fresh (B2). It is also possible for the lactams present in the gaseous discharge from the treatment zone to be at least partly removed in a scrubbing column. The lactams and lactam-water mixtures used as treatment medium (B1) are examples of suitable scrubbing media.

The process of the present invention, as mentioned, specifically provides for an integration of hydrolytic polymerization and purification of crude particles of polymer obtained therein wherein the laden treatment medium (B2) is preferably also included.

In one specific embodiment of the process according to the present invention, crude particles of polyamide are provided in step a) from a hydrolytic polymerization of at least one lactam and the water quantity generated in steps b) and c) in the form of the laden treatment media B1) and B2) does not exceed the water quantity required to kick off the hydrolytic polymerization in step a).

In one specific embodiment of the process according to the present invention, crude particles of polyamide are provided in step a) from a hydrolytic polymerization of at least one lactam and the amount of monomers and oligomers which is generated in steps b) and c) in the form of the laden treatment media B1) and B2) does not exceed the amount of monomers and oligomers which is used in step a) for hydrolytic polymerization.

Aftertreatment (Drying and/or Postpolymerization)

After treatment with the first liquid treatment medium (B1) and with the second gaseous treatment medium (B2), the polyamide particles can be subjected to an aftertreatment. This preferably includes a postpolymerization and/or drying step for the polyamide particles.

The process of the present invention eliminates the need for an aftertreatment for a multiplicity of uses for the polyamide particles.

In one suitable embodiment, the purified particles of polymer are subjected to additional drying and/or postpolymerization. Useful apparatuses for performing the aftertreatment include for example centrifuges, shaft dryers, crossflow dryers, belt dryers, fluidized bed dryers, etc. The aftertreatment temperature is preferably in a range of 100 to 200° C., more preferably 120 to 190° C. and especially 130 to 180° C. In one preferred variant, aftertreatment is effected in vacuo.

The polyamide particles obtainable by the process of the present invention preferably have a viscosity number of 100 to 400 ml/g, more preferably of 110 to 300 ml/g and especially of 115 to 250 ml/g.

The polyamide particles obtainable by the process of the present invention preferably have a monomeric content of 0.001 to 5 wt %, more preferably 0.005 to 2.5 wt %, especially 0.01 to 1 wt % and specifically 0.02 to 0.08 wt %, based on the total weight of polyamide particles.

The polyamide particles obtainable by the process of the present invention preferably have an oligomeric content of 0.001 to 10 wt %, more preferably 0.005 to 5 wt %, especially 0.01 to 1 wt % and specifically 0.1 to 0.5 wt %, based on the total weight of polyamide particles.

The polyamide particles obtainable by the process of the present invention preferably have a number-average molecular weight Mn of 1000 to 500 000 g/mol, more preferably 5000 to 200 000 g/mol and especially 10 000 to 50 000 g/mol.

The polyamide particles obtainable by the process of the present invention are very useful for producing chips, film/sheet, fibers or shaped articles.

The polyamide particles treated according to the present invention are specifically useful for producing packaging film, monofilaments, injection-molded parts and polyamide fibers.

The invention is further elucidated by the following, nonlimiting examples:

### EXAMPLES

The viscosity number is determined according to DIN 51562 Part 1 using a Ubbelohde viscometer. To determine the viscosity number, 30 g of chip material in each case was extracted for 12 h with hot (95° C.) completely ion-free water (flowrate: 101/h) in a stirred jacketed vessel and then dried at 90° C. in a vacuum drying cabinet at 50 mbar. The purified polyamide chip material was dissolved in 96±0.1% sulfuric acid to determine the viscosity number VZ in a concentration of 0.5% (m/v). The flow times of the sample solution and of the solvent were determined in a Ubbelohde viscometer at 25.0±0.05° C. water bath temperature and used to compute the viscosity number/relative viscosity.

Residual monomer/oligomer content was determined directly from the chip material by HPLC chromatography.

### Examples 1 to 2

### Purifying a Crude Nylon-6 Chip Material in the Liquid Phase (1^{st} Purification Stage)

100 g of polyamide chip material having a Vz of 135 g/ml and 89 g of 100% caprolactam flakes in a stirred tank extractor were inertized with nitrogen (10 I/h) at room temperature under gentle agitation (at a low speed of about 50 rpm) for 30 minutes and subsequently treated for “M” hours at a temperature “T” (values see table A), the hot chip material was separated from the caprolactam using a frit temperature-controlled to 110° C. and then residual caprolactam was centrifuged off to obtain 100 to 103 g of extracted polyamide chip material.

The results are summarized in table A.

TABLE A

| | Extraction | | [g/100 g] of caprolactam oligomer | | | | |
|---|---|---|---|---|---|---|---|
| | T | M | Di- | Tri- | Tetra- | Penta- | Hexa- |
| Example | [° C.] | [h] | mer | mer | mer | mer | mer |
| Crude | — | — | 1.251 | 0.803 | 0.652 | 0.519 | 0.289 |
| polyamide | | | | | | | |
| 1 | 140 | 16 | 0.205 | 0.116 | 0.118 | 0.147 | 0.125 |
| 2 | 150 | 5 | 0.205 | 0.136 | 0.130 | 0.134 | 0.094 |

### Example 3

### 3.1) Extraction with Caprolactam

120 g of crude polyamide chip material having a VZ of 110 g/ml and 1200 g of 100% caprolactam flakes were inertized with nitrogen (101/h) at room temperature under gentle agitation (at a low speed of about 50 rpm) for 30 minutes and subsequently treated for 16 hours at a temperature of 95° C., the hot chip material was separated from the caprolactam using a frit temperature-controlled to 110° C. and then residual caprolactam was centrifuged off to obtain 122 g of polyamide chip material extracted to remove oligomers. The results are shown in table B.

### 3.2) Treatment with Nitrogen

80 g of the extracted product from Example 3.1) were placed in an extractor consisting of a jacketed tube with a frit base and 300 I/h of nitrogen was made to flow through it upwardly at 180° C. and standard pressure (1013 mbar) for 48 h and the gas was passed through a cold trap to condense out the condensables dissolved therein. Thereafter, the polyamide chip material was cooled down with cold nitrogen and removed from the extractor. The results are collated in table B.

TABLE B

| | Total extractables | of which | |
|---|---|---|---|
| | content | monomer | VZ |
| | [%] | [%] | [ml/g] |
| crude polyamide | 13.12 | 9.44 | 135 |
| after extraction | 14.36 | 14.27 | 135 |
| after N₂ treatment | 0.57 | 0.060 | 242 |

1-29. (canceled)

30. A process for producing polyamide particles, which comprises
a) providing crude particles of polyamide,
b) contacting the crude particles of polyamide provided in step a) in a treatment zone with a first liquid treatment medium (B1) comprising at least one lactam and removing the laden treatment medium (B1),
c) optionally contacting the crude particles of polyamide additionally with a second gaseous treatment medium (B2).

31. The process according to claim 30, wherein the crude particles of polyamide are additionally contacted with a second gaseous treatment medium (B2) in step c) and the treatment with the second treatment medium (B2) is carried out simultaneously with the treatment with the first treatment medium (B1) or wholly or partly after the treatment with the first treatment medium (B1).

32. The process according to claim 30, wherein crude particles of polyamide are provided in step a) from a hydrolytic polymerization of at least one lactam.

33. The process according to claim 30, wherein crude particles of polyamide are provided in step a) which comprises caprolactam in polymerized form.

34. The process according to claim 30, wherein crude particles of polyamide are provided in step a) which comprise monomeric and/or oligomeric components from the polyamide production process.

35. The process according to claim 30, wherein the first treatment medium (B1) consists exclusively of at least one lactam or wherein the first treatment medium (B1) comprises at least one lactam and water.

36. The process according to claim 30, wherein the second treatment medium (B2) is steam, nitrogen, helium, neon, argon, CO2 and mixtures thereof.

37. The process according to claim 30, wherein nitrogen is used as second treatment medium (B2).

38. The process according to claim 30, wherein the crude particles of polyamide are provided in step a) by
a1) providing a monomer mixture comprising at least one lactam monomer and/or oligomer,
a2) reacting the monomer mixture provided in step a1) in a hydrolytic polymerization in the presence of water to obtain a reaction mixture comprising polyamide, water, unconverted monomers and oligomers, and
a3) forming the reaction mixture obtained in step a2) into crude particles of polyamide.

39. The process according to claim 30, wherein the crude particles of polyamide in step b) pass through the treatment zone in countercurrent with the first liquid treatment medium (B1).

40. The process according to claim 30, wherein the treatment zone in step b) is substantially vertical and the crude particles of polyamide pass downwardly through the treatment zone in countercurrent with the first liquid treatment medium (B1) and in accordance with the force of gravity and the liquid treatment medium (B1) passes upwardly contrary to the force of gravity.

41. The process according to claim 30, wherein the treatment medium (B1) is at least partly or exclusively introduced into the treatment zone in the region of the end where the polyamide particles are discharged.

42. The process according to claim 30, wherein a sub-stream of treatment medium (B1) is fed into the treatment zone in the region of the end where the polyamide particles are discharged and a further sub-stream of treatment medium (B1) is fed to the treatment zone via one or more feedpoints located upstream of the feedpoint of the first sub-stream.

43. The process according to claim 42, wherein the lactam content of the sub-stream of treatment medium (B1) introduced into the treatment zone in the region of the content of the sub-stream of treatment medium (B1) which is fed to the treatment zone via one or more feedpoints located upstream of the feedpoint of the first sub-stream.

44. The process according to any of claim 41, wherein exclusively at least one lactam is fed as treatment medium (B1) into the treatment zone in the region of the end where the polyamide particles are discharged.

45. The process according to claim 42, wherein a water-lactam mixture or pure water is fed as second sub-stream of treatment medium (B1) into the treatment zone via one or more feedpoints located upstream of the feedpoint for the first sub-stream.

46. The process according to claim 42, wherein the contacting of treatment medium (B1) with the crude particles of polyamide in step b) is effected continuously and the weight ratio of laden treatment medium (B1) removed per unit time to polyamide particles discharged from the treatment zone per unit time is in a range of 0.01:1 to 1:1.

47. The process according to claim 42, wherein the treatment medium (B1) or one or more than one sub-stream of treatment medium (B1) is recirculated.

48. The process according to claim 42, wherein the treatment zone in step b) has a higher temperature in the region where the crude particles of polyamide are introduced than in the region where the polyamide particles are discharged.

49. The process according to claim 48, wherein the temperature difference between the region where the crude particles of polyamide are introduced and the region where the polyamide particles are discharged is not less than 5° C.

50. The process according to claim 48, wherein the laden treatment medium (B1) removed in step b) is returned into a polymerization to provide the crude

51. The process according to claim 32, wherein crude particles of polyamide are provided in step a) from a hydrolytic polymerization of at least one lactam and the water quantity generated in step b) in the form of the laden treatment medium B1) does not exceed the water quantity required to kick off the hydroytic polymerization in step a).

52. The process according to claim 32, wherein crude particles of polyamide are provided in step a) from a hydrolytic polymerization of at least one lactam and the amount of monomers and oligomers which is generated in step b) in the form of the laden treatment medium B1) does not exceed the amount of monomers and oligomers which is used in step a) for hydrolytic polymerization.

53. The process according to claim 31, wherein at least some of the components dissolved in the laden treatment medium (B2) are removed therefrom by condensation.

54. The process according to claim 53 wherein the components condensed out of the laden treatment medium (B1) are at least partly returned into a polymerization to provide the crude particles of polyamide in step a).

55. The process according to claim 32, wherein crude particles of polyamide are provided in step a) from a hydrolytic polymerization of at least one lactam and the water quantity generated in steps b) and c) in the form of the laden treatment media B1) and B2) does not exceed the water quantity required in step a) to kick off the hydrolytic polymerization.

56. The process according to claim 32, wherein crude particles of polyamide are provided in step a) from a hydrolytic polymerization of at least one lactam and the amount of monomers and oligomers which is generated in steps b) and c) in the form of the laden treatment media B1) and B2) does not exceed the amount of monomers and oligomers which is used in step a) for hydrolytic polymerization.

57. The process according to claim 56, wherein the polyamide particles which have been treated with the first liquid treatment medium (B1) and optionally with the second gaseous treatment medium (B2) are subjected to an aftertreatment (=step d).

58. A process for producing chips, film/sheet, fibers or shaped articles which comprises utilizing purified particles of polyamide obtainable by the process as defined in claim 30.
